(19) United States
(12) Patent Application Publication
(10) Pub. No.: US 2012/0144638 A1
(43) Pub. Date: Jun. 14, 2012

(54) DEVICE FOR PRODUCING A HOT-ROLLED THERMAL STRIP, ESPECIALLY MADE OF STRIP-TYPE CONTINUOUS CASTING MATERIAL

(75) Inventors: Christoph KLEIN, Kreuztal (DE); Jürgen MÜLLER, Kaarst (DE); Karl RITTNER, Hilden (DE); Dieter ROSENTHAL, Niederfischbach (DE)

(73) Assignee: SMS SIEMAG AKTIENGESELLSCHAFT, Dusseldorf (DE)

(21) Appl. No.: 13/400,897

(22) Filed: Feb. 21, 2012

Related U.S. Application Data
(63) Continuation of application No. 10/563,264, filed on Sep. 18, 2006, now abandoned.

(30) Foreign Application Priority Data
Jul. 3, 2003 (DE) 103 30 210.7

(51) Int. Cl. B23P 23/06; B22D 11/14; B21B 1/46

(52) U.S. Cl. 29/33 C

(57) ABSTRACT

An installation for producing hot-rolled steel strip, including a continuous casting machine, a shear, a soaking furnace, a descaler, possibly a roughing train, a finishing train including a multi-stand rolling mill or Steckel mill, a roller table with a cooling zone, and a coiling reel for the hot strip. The casting line and the pass line are arranged parallel or approximately parallel to each other so that the casting direction and the rolling direction are oriented opposite each other and are connected with each other by a reheating furnace. The reheating furnace is a rocker-bar hearth furnace or a walking-beam furnace. The distance between the casting line and the pass line is designed so that a sufficient residence and buffering time for the thin slabs in the reheating furnace is guaranteed. The reheating furnace is designed to hold from three to twelve slabs.

### CROSS-REFERENCE TO RELATED APPLICATIONS

The present application is a Continuation Application of U.S. patent application Ser. No. 10/563,264, filed Sep. 18, 2006, which is a 371 of International application PCT/EP2004/006505, filed Sep. 18, 2006, which claims priority of DE 103 30 210.7, filed Jul. 3, 2003, the priority of these applications is hereby claimed and these applications are incorporated herein by reference.

### BACKGROUND OF THE INVENTION

The invention concerns an arrangement for producing hot-rolled steel strip, which comprises at least one continuous casting machine, at least one shear, at least one soaking furnace, a descaler, possibly a roughing train, a finishing train (multi-stand rolling mill or Steckel mill(s)), a roller table with a cooling zone, and at least one coiling reel for the hot strip.

In modern thin-slab and medium-slab installations, the casting machine, the shear, the reheating/soaking furnace, the multistand rolling mill, the runout roller table with cooling zone, and coiling reel are arranged in line. In multistrand installations, the casting machines and the reheating furnaces are arranged side by side parallel to one another. The slabs are transferred to the pass line by so-called transport ferries. An installation concept of this type requires installation lengths of 300-500 m.

The document DE 42 36 307 A1 discloses a method and an arrangement for producing hot-rolled steel strip from continuously cast feed material, preferably thin slabs, wherein after the feed material cast in the casting machine has solidified, it is cut by shears to suitable lengths that correspond to the desired coil weight. The thin slabs are homogenized in a soaking furnace, roughed in a roughing train, finish rolled in a finishing train, cooled in a cooling zone, and coiled on a coiler. In regard to different grades of steel, the thin slabs are heated to temperatures above 1,150° C. after the homogenization and before the first roughing pass. The slabs are then roughed, and the roughed strip is recrystallized and cooled to the rolling temperature for the finishing train and then finish rolled. The installation for producing hot-rolled strip includes two parallel continuous casting machines with two shears and two soaking furnaces. The soaking furnaces are followed by a thin-slab transport ferry with a ferry car. The ferry car is used to transport the thin slabs alternately from each soaking furnace to the other pass line. To guarantee a constant casting and rolling operation, a storage facility for the cast thin slabs is provided after the transport ferry. The storage facility can be heated or unheated and is arranged in line with the rolling train.

The document DE 40 41 206 A1 describes a method and an installation for producing hot-rolled steel strip, especially for high-grade steels consisting of continuously cast feed material. The feed material cast in the casting machine is allowed to solidify and is then cut to length to produce thin slabs, which are homogenized and heated to rolling temperature in a soaking furnace, fed into a rolling mill, and finish rolled to predetermined final dimensions in a series of passes. A thin slab is transferred from the soaking furnace to a ferry, which moves it laterally from its original position in the line with the continuous casting machine to a parallel line of a rolling train, and simultaneously or previously, a section of the roller table corresponding to the ferry is moved, likewise transversely, out of the line of the rolling train. The thin slab is then accelerated out of the ferry to rolling speed, fed into the rolling train, and roughed into a coilable coil in an initial run. Immediately after it has run out of the last stand, it is fed into a hot box, in which it is coiled to prevent temperature loss. The roller table segment and, simultaneously or previously, the ferry are moved back into their original positions, the rolling mill is changed over to reversing operation, and the strip is uncoiled from the caller of the hot box in reversing operation, finish rolled, run out of the now last stand via the roller table, and coiled into a coil in a terminal coiling station.

The document WO 92/00815 concerns an installation for producing hot-rolled strip that has been rolled out from previously cast thin slabs. The installation consists of a casting machine with a ladle and tundish for the molten steel and a mold, into which the cast steel flows from the tundish, and the thin slab emerges at the lower end of the mold. The casting machine is followed by a roughing mill, which is followed by a shearing device, in which the cast strip is cut to slab length. This is followed by an induction furnace as a temperature homogenization and reheating furnace, which is followed by a hot box for the prestrip, which has been reduced in thickness. Downstream of the hot box, there is a multistand rolling mill, a roller table with a cooling zone, a finish rolling mill, and a coiler for the finish rolled hot-rolled strip.

A common feature of the aforementioned prior art is that all of the units and machines of the installation are arranged in a line. These plant concepts result in considerable installation lengths, regardless of whether these installations are arranged side by side in line and are connected with one another with ferries.

The document DE 32 41 745 A1 discloses an arrangement for producing hot-rolled steel strip that consists of a casting machine, shear, coiling device, furnace, uncoiling device, hot box, rolling stand, hot box, and underfloor coiler. The plant components are arranged in line parallel to one another and are connected with one another by the rotary hearth furnace. This document discloses that the casting and rolling direction are oppositely oriented, so that the plant can be housed in the smallest possible space. A prerequisite here is that a coiling device and an uncoiling device are part of the plant.

The document EP 0 045 400 A1 discloses an installation for the casting and rolling of metals to produce rod and wire sections, which consists of a casting machine, secondary cooling line, temperature homogenization line, a drive unit, separating shear, a transversely displaceable roughing train, a first intermediate train, a curved 180° deflecting arrangement, a second intermediate train, a finishing train, a primary cooling line, a laying head, a secondary cooling line and a collecting station. This document discloses that the casting and rolling direction are oppositely oriented. However, casting is carried out only by one casting machine at a time. The roughing train is assigned to the given casting machine by transverse displacement. Rolling units are installed upstream of the reheating furnace, which joins the casting line and pass line. The casting line and pass line are connected by curved deflection of the rolled product.

The document GB 2 302 054 A discloses an installation for the casting and rolling of a thin slab, e.g., with a thickness of 80 mm, which consists of a casting machine, shear, roller hearth furnace, heatable rotary table, roughing stand, roller hearth furnace, shear, descaler, rolling train, and coiler. This document describes an arrangement of the casting and rolling units at an angle of 90°. The casting and rolling line are not oppositely oriented.

The document DE 40 41 206 A1 discloses a method for producing hot-rolled steel strip. The pass line is arranged parallel to the casting line, and the two lines are connected by a heatable ferry. Rolling is first carried out in the casting direction with the first rolling stand open. The first stand is then closed, and the strip is finish rolled in reversing operation.

### SUMMARY OF THE INVENTION

Proceeding on the basis of the aforementioned prior art, the objective of the invention is to create a new plant concept, in which the space requirements and especially the length of the installation are significantly smaller.

In accordance with the invention, this objective is achieved by arranging the casting line and the pass line parallel or approximately parallel side by side in such a way that the casting direction and the rolling direction are oriented essentially opposite each other and are connected with each other by a reheating furnace, such that the reheating furnace is a rocker-bar hearth furnace or a walking-beam furnace. In a surprisingly simple way, this measure very considerably reduces the previously known length of thin-slab installations and for the first time makes available a compact installation for the production of thin strip, such that the reheating furnace feeds the slabs from the casting line to the pass line and at the same time raises the temperature of the slabs to the required initial pass temperature. A rocker-bar hearth furnace or a walking-beam furnace is an especially suitable reheating furnace.

In a continuation of the idea of the invention, it is proposed that the distance between the casting line and the pass line be designed in such a way that a sufficient residence and buffering time in the reheating furnace is guaranteed. In accordance with a further proposal, the preheating furnace is designed in such a way that at least three slabs and a maximum of twelve slabs can be held in the soaking furnace.

In accordance with a refinement of the invention, the casting line consists of one or more casting machines or several cast strands, which are advantageously positioned at the same height.

In accordance with the invention, it is further proposed that at least one continuous furnace be arranged between the casting machine and the reheating furnace. In addition, it is regarded as advantageous for at least one continuous furnace to be arranged between the rolling mill and the reheating furnace.

The invention is schematically described in greater detail below with reference to specific embodiments.

The various features of novelty which characterize the invention are pointed out with particularity in the claims annexed to and forming a part of the disclosure. For a better understanding of the invention, its operating advantages, specific objects attained by its use, reference should be had to the drawings and descriptive matter in which there are illustrated and described preferred embodiments of the invention.

### BRIEF DESCRIPTION OF THE DRAWING

In the drawing:

FIG. 1 shows a functional block diagram that illustrates the oppositely directed arrangement of the casting line and pass line and a soaking furnace connecting the two lines.

FIG. 2 shows a functional block diagram that illustrates the oppositely directed arrangement of the casting line and pass line in accordance with FIG. 1, with the addition of a continuous pusher-type furnace downstream of the casting machine.

FIG. 2a shows a functional block diagram that illustrates the installation in accordance with FIG. 1, but with a continuous pusher-type furnace assigned to the casting machine and another such furnace assigned to the rolling mill.

### DETAILED DESCRIPTION OF THE INVENTION

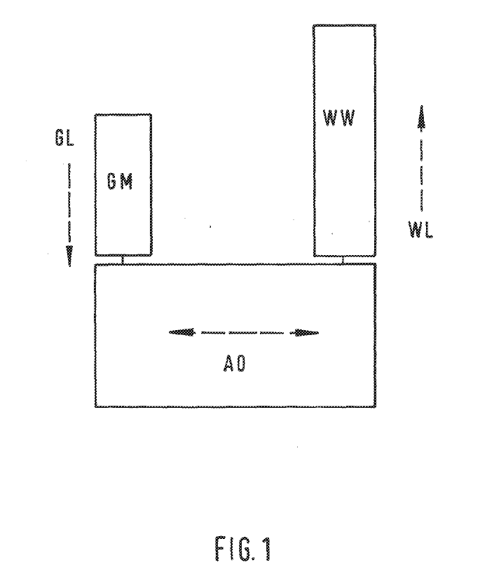

FIG. 1 shows the compact installation of the invention, in which the casting line GL and pass line WL are arranged parallel to each other and are oppositely directed. The casting line and the pass line are connected by a reheating furnace AO, which acts as a ferry to feed the slabs from the casting line to the pass line and at the same time raises the temperature of the slabs to the required initial pass temperature for the rolling mill WL. At least three slabs and a maximum of twelve slabs can be held in the reheating furnace AO. The distance between the casting line with the casting machine GM and the pass line with the rolling mill WW is designed in such a way that a sufficient residence and buffering time in the reheating furnace is guaranteed.

As is well known, the casting line GL consists of several units and machines and generally comprises a casting ladle and a tundish for holding the molten metal to be cast, and of a mold, into which the molten metal is poured from the tundish through a pouring nozzle and tube and is cast into a thin slab in the mold. The thin slab is then cooled in a curved support frame and is cut to the so-called coil weight by means of a cut-to-length shearing device. For the sake of simplicity, these parts of the installation are not shown.

A stepped rocker-bar hearth furnace or a walking-beam furnace is used as the reheating furnace.

As is well known, the pass line WL consists of a descaler, possibly a roughing stand, a multistand rolling mill, possibly at least one Steckel mill, followed by a roller table with a cooling arrangement for the hot-rolled strip and followed by at least one coiler for coiling the finish rolled strip to the so-called coil weight. These parts of the plant are also not shown.

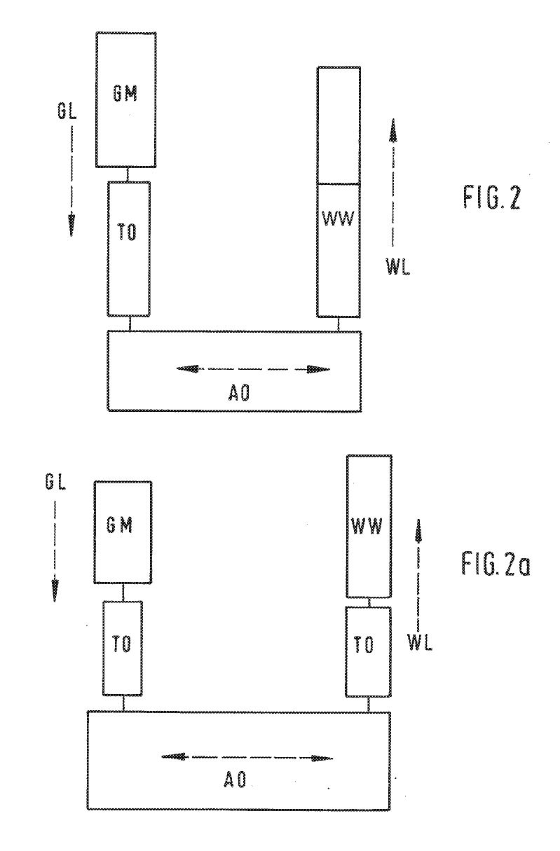

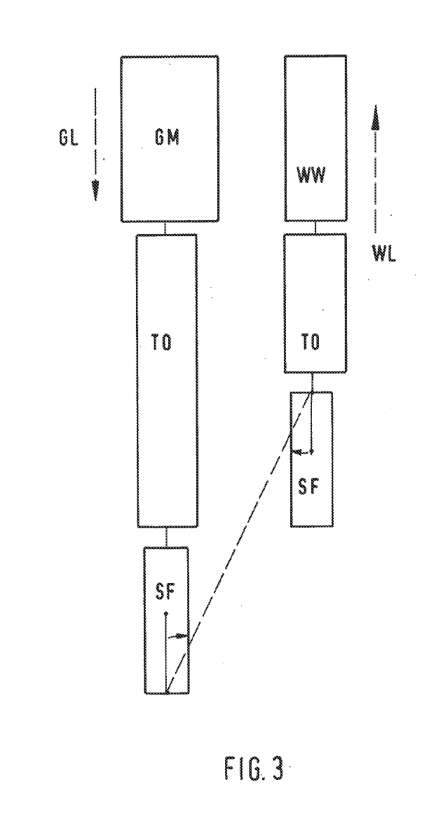

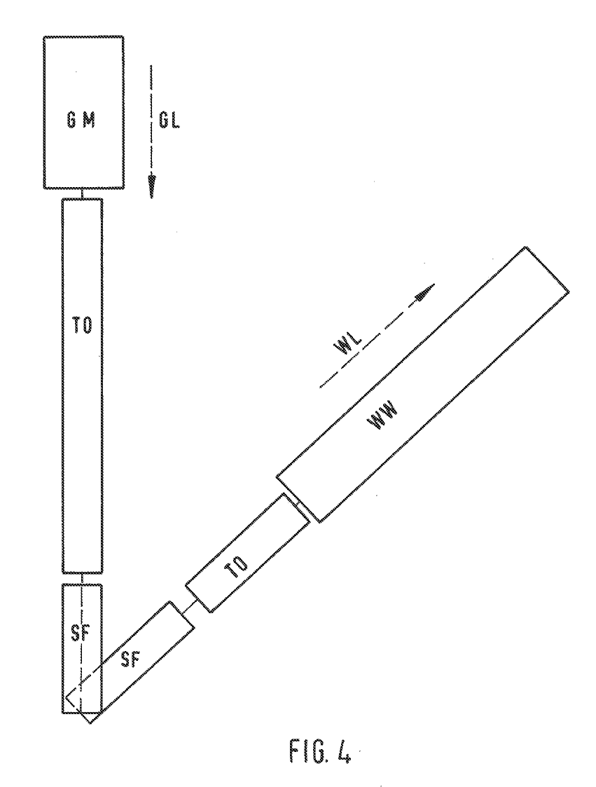

FIG. 2 and FIG. 2a show the compact installation of the invention with casting line GL and pass line WL, such that the casting direction of the casting machine GM runs counter to the rolling direction in the rolling mill WW. In addition, a continuous furnace in the form of a continuous pusher-type furnace TO is located downstream of the casting machine and upstream of the reheating furnace AO. In FIG. 2a, the compact installation in accordance with FIG. 2 is supplemented by a continuous furnace in the form of a continuous pusher-type furnace TO downstream of the reheating furnace and upstream of the rolling mill.

FIG. 3 shows the invention's basic concept of oppositely directed arrangement of the casting line GL and pass line WL, such that a continuous pusher-type furnace TO is located downstream of the casting machine GM, and another continuous pusher-type furnace TO is located upstream of the rolling mill WW, and the two continuous pusher-type furnaces are connected with each other by a swivel ferry SF.

FIG. 4 shows an alternative compact installation of the invention with largely oppositely directed casting line and pass line, with which it is possible to allow for different spatial requirements and requirements with respect to floor space in such a way that, for example, the casting line and the pass line are not arranged parallel to each other but rather are arranged relative to each other at a certain angle α, such that 0°<α<150°. An L-shaped compact installation is preferably arranged with this measure.

While specific embodiments of the invention have been shown and described in detail to illustrate the inventive principles, it will be understood that the invention may be embodied otherwise without departing from such principles.

We claim:

1. An installation for producing hot-rolled steel strip, which comprises at least one continuous casting machine, at least one shear, at least one soaking furnace, a descaler, possibly a roughing train, a finishing train including a multi-stand rolling mill or Steckel mill, a roller table with a cooling zone, and at least one coiling reel for the hot strip, wherein the casting line and the pass line are arranged parallel or approximately parallel to each other in such a way that the casting direction and the rolling direction are oriented essentially opposite each other and are connected with each other by a reheating furnace, and by the fact that the reheating furnace is a rocker-bar hearth furnace or a walking-beam furnace, wherein the distance between the casting line and the pass line is designed in such a way that a sufficient residence and buffering time for the thin slabs in the reheating furnace is guaranteed, the reheating furnace being designed to hold at least three slabs and a maximum of twelve slabs.

2. The installation in accordance with claim 1, wherein the casting line consists of one or more casting machines or several cast strands.

3. The installation in accordance with claim 1, wherein the casting and rolling plane are preferably arranged at the same height.

4. The installation in accordance with claim 1, wherein at least one continuous furnace is arranged between the casting machine and the reheating furnace.

5. The installation in accordance with claim 1, wherein at least one continuous furnace is arranged between the rolling mill and the reheating furnace.
